(19) United States
(12) Patent Application Publication
(10) Pub. No.: US 2010/0114763 A1
(43) Pub. Date: May 6, 2010

(54) METHODS AND SYSTEMS FOR PROVIDING CASH ALTERNATIVE DEBITING AND ACCOUNTING FUNCTIONS FROM ASSOCIATED CASH AND CREDIT, OR CREDIT, ACCOUNTS

(76) Inventor: Ronald John Rosenberger, Newtown, PA (US)

Correspondence Address: Guy Kevin Townsend, 1079 S. VAN GORDON COURT, LAKEWOOD, CO, 80228, US

(21) Appl. No.: 12/596,444

(22) PCT Filed: Apr. 20, 2008
(86) PCT No.: PCT/US08/60956

§ 371 Date: Oct. 18, 2009

Related U.S. Application Data
(60) Provisional application No. 60/925,426, filed on Apr. 20, 2007.

(51) Int. Cl. G06Q 40/00; G06Q 30/00

(52) U.S. Cl. 705/40; 705/39

(57) ABSTRACT

The present invention provides cash using alternative debiting and accounting functions from associated cash and credit, or “crebit”, accounts that allow flexibility and control by the end user for providing cash and then providing alternative debiting and accounting of such withdrawal or multiple withdrawals using alternative debiting and accounting functions from the associated cash and credit “crebit” accounts, that further provide opportunities for the account provider or financial institution to have additional income from providing such methods and systems.

### FIELD OF THE INVENTION

The present invention provides cash using alternative debiting and accounting functions from associated cash and credit “crebit” accounts that allow flexibility and control by the end user for providing cash and then providing alternative debiting and accounting of such withdrawal or multiple withdrawals using alternative debiting and accounting functions from the associated cash and credit “crebit” accounts, that further provide opportunities for the account provider or financial institution to have additional income from providing such methods and systems.

### BACKGROUND OF THE RELATED ART

Known ATM cards enable account holders to withdraw cash from their cash accounts at ATM machines or bank branches, whereby at least one of the user's available cash balances is debited for the amount of the withdrawal, plus fees or charges if applicable. Known credit cards enable account users to withdraw cash advances on their credit accounts at ATM machines or bank branches, plus fees and/or interest rates that can be higher than for credit purchases, and where a given fee can be a flat fee or a percentage of the withdrawn cash amount. Such cash advances debit the available credit balance of the credit card account, and are repaid by the end user at a later time with fees and interest. Such known methods suffer from the problems of not being able to provide flexible and alternative ways to provide cash other than as cash withdrawals from cash accounts or cash advances on credit accounts.

### SUMMARY OF THE PRESENT INVENTION

The present invention provides cash using alternative debiting and accounting functions from associated cash and credit “crebit” accounts that allow flexibility and control by the end user for providing cash, and then providing alternative debiting and accounting of such withdrawal or multiple withdrawals using alternative debiting and accounting functions from the associated cash and credit “crebit” accounts that further provide opportunities for the account provider or financial institution to have additional income from providing such methods and systems. A given “crebit” embodiment may comprise any combination or permutation of in-house, and/or out-of-house available credit and/or cash balances.

The present invention also provides in one aspect methods and systems for making flexible or pre-assigned withdrawals from two or more associated accounts in a “crebit” account that comprises at least one credit account and at least one cash account that can be employed to enable cash withdrawals that include both credit and debit aspects. These “crebit” methods and systems that can include where a given purchase transaction debits an initial available credit balance, and within any time interval, such as such as immediately upon or after the debit to the initial available credit balance occurs, or, two minutes, two hours, two days, etc., after the debit to the initial available credit balance occurs, said debit is credited automatically, or “paid in-turn”, by a debit to at least one available cash balance; or, a plurality of debits to the initial available credit balance are automatically “paid together” at once at any given time interval, such as at or after the end of a billing cycle. Similarly, the abovementioned special “crebit” methods can be adapted for cash withdrawals from an ATM or bank branch, whereby the cash withdrawal does not directly debit at least one available cash balance associated with the “crebit” account; rather, an available credit balance associated with the “crebit” account is debited, and cash is disbursed to the end user via ATM or bank branch, whereby the debit to the credit balance created by the cash withdrawal is subsequently credited by a debit to said available cash balance(s).

### DESCRIPTION OF THE INVENTION

The present invention provides cash using alternative debiting and accounting functions from associated cash and credit “crebit” accounts that allow flexibility and control by the end user for providing cash and then providing alternative debiting and accounting of such withdrawal or multiple withdrawals using alternative debiting and accounting functions from the associated cash and credit “crebit” accounts, that further provide opportunities for the account provider or financial institution to have additional income from providing such methods and systems. In one aspect a method is provided for making at least one flexible or pre-assigned cash withdrawal from two or more associated accounts comprising at least one credit account and at least one cash account, the method comprising (a) providing said at least one credit account associated with at least one cash account with user access for at least one cash withdrawal; (b) making said at least one cash withdrawal from at least one initial available credit balance or combination thereof, and within at least one time interval after said cash withdrawal, at least one debit corresponding to at least a portion of said cash withdrawal is credited to at least a part of said at least one cash account or said at least one credit account.

In such a method, said portion of said cash withdrawal can be any percentage or portion of said at least one cash withdrawal amount. In such a method, the percentage is 0.001 to 100 percent or any portion thereof. In such a method, the portion is 0.001 to at least 100,000 US dollars or any foreign equivalent thereof. In such a method, the at least one debit is paid off by at least one cash balance of said at least one cash account. In such a method, the timing of at least one debit pay off is at any given time interval after said cash withdrawal, or where at least one debit pay off is automatically “paid together” at once at any given time interval, such as at or after the end of at least one billing cycle of said at least one credit or cash account, wherein said time interval or billing cycle from said at least one credit or cash account can be modified, extended, or transferred to a different credit or cash account. In such a method, the time interval is selected from immediately, <1-60 seconds, 1-60 minutes, 1-24 hours, 1-52 weeks, 1-50 years, or any portion thereof. In such a method, the at least one debit can be transferred to another credit or cash account. In such a method, the pay off is done automatically based on any parameter set by the end user or any default parameter set by the account provider of said at least one cash account and said at least one credit account. In such a method, the at least one cash withdrawal includes multiple cash withdrawals. In such a method, the debits relating to said multiple cash withdrawals are paid in any specific order or combination selected by default settings, the end user, or the account provider. In such a method, the order or combination is selected from chronological, withdrawal amount, debit amount, a threshold amount, a maximum amount or a minimum amount, or any combination thereof. Such a method can further comprise wherein said at least one debit is moved from at least one credit account or at least one cash account to at least one other credit account or at least one other cash account.

In such a method, the other credit account has a different billing cycle. In such a method, prior to or at the time of said cash withdrawal, an available cash balance is increased by transferring at least one cash balance in at least one of said cash accounts to at least one credit balance in at least one credit accounts, such that said available cash balance is increased by an automatic or predetermined amount. In such a method the transferred cash balance can be paid back at a later time. The present invention also provides a system for making at least one flexible or pre-assigned cash withdrawal from two or more associated accounts comprising at least one credit account and at least one cash account, comprising (a) a system component for providing said at least one credit account associated with at least one cash account with user access for at least one cash withdrawal; (b) a system component for making said at least one cash withdrawal from at least one initial available credit balance or combination thereof, and within at least one time interval after said cash withdrawal, at least one debit corresponding to at least a portion of said cash withdrawal is credited to at least a part of said at least one cash account or said at least one credit account. In such a system, the portion of said cash withdrawal can be any percentage or portion of said at least one cash withdrawal amount. In such a system, the percentage is 0.001 to 100 percent or any portion thereof. In such a system, the portion is 0.001 to at least 100,000 US dollars or any foreign equivalent thereof. In such a system, the at least one debit is paid off by at least one cash balance of said at least one cash account. In such a system, the timing of at least one debit pay off is at any given time interval after said cash withdrawal, or where at least one debit pay off is automatically “paid together” at once at any given time interval, such as at or after the end of at least one billing cycle of said at least one credit or cash account, wherein said time interval or billing cycle from said at least one credit or cash account can be modified, extended, or transferred to a different credit or cash account.

In such a system, the time interval is selected from immediately, <1-60 seconds, 1-60 minutes, 1-24 hours, 1-52 weeks, 1-50 years, or any portion thereof.

In such a system, the at least one debit can be transferred to another credit or cash account. In such a system, the pay off is done automatically based on any parameter set by the end user or any default parameter set by the account provider of said at least one cash account and said at least one credit account. In such a system, the at least one cash withdrawal includes multiple cash withdrawals. In such a system, the debits relating to said multiple cash withdrawals are paid in any specific order or combination selected by default settings, the end user or the account provider. In such a system, the order or combination is selected from chronological, withdrawal amount, debit amount, a threshold amount, a maximum amount or a minimum amount, or any combination thereof. Such a system can optionally further comprise wherein said at least one debit is moved from at least one credit account or at least one cash account to at least one other credit account or at least one other cash account. In such as system, the other credit account can have a different billing cycle.

In such as system can optionally further comprise wherein prior to or at the time of said cash withdrawal, an available cash balance is increased by transferring at least one cash balance in at least one of said cash accounts to at least one credit balance in at least one credit accounts, such that said available cash balance is increased by an automatic or predetermined amount.

In such a system, the transferred cash balance is paid back at a later time.

These and other aspects of the present invention are further described, but not limited by, the following examples, which are only illustrative of specific examples of the present invention.

### EXAMPLES

In the examples to follow, cash withdrawals are exemplified. It should be understood that such cash withdrawals can take place anywhere that allows them, such as ATM machines, bank branches, retail merchants, etc. What is especially important to understand is that all of the methods disclosed earlier regarding purchase transactions can be adapted to cash withdrawals, so while the following examples will attempt to be illustrative, they are non-limiting, and variants of cash withdrawal methods should be considered commensurate to the numerous purchase transaction methods presented earlier.

This first example shows a common, everyday, cash withdrawal, whereby each withdrawal debits an end user's available cash balance:

| | | Amount | Amt Debited |
|---|---|---|---|
| Date | Description | Withdrawn | Frm Cash Bal |
| 01-02 | Cash Withdrawal | 40.00 | 40.00 |
| 01-09 | Cash Withdrawal | 20.00 | 20.00 |
| 01-15 | Cash Withdrawal | 60.00 | 60.00 |
| 01-20 | Cash Withdrawal | 40.00 | 40.00 |
| 01-23 | Cash Withdrawal | 20.00 | 20.00 |
| 01-28 | Cash Withdrawal | 80.00 | 80.00 |
| | TOTAL | 260.00 | 260.00 |

Less traditionally, user-adjustable cash withdrawal parameters can enable the automatic debiting of two or more available cash balance funding sources. In the following example using an amount threshold parameter, cash withdrawals up to $40 debit cash balance #1, whereby cash withdrawals above $40 debit cash balance #2.

| | | Amount | Cash Bal | Cash Bal |
|---|---|---|---|---|
| Date | Description | Withdrawn | #1 Debit | #2 Debit |
| 01-02 | Cash Withdrawal | 40.00 | 40.00 | -0- |
| 01-09 | Cash Withdrawal | 20.00 | 20.00 | -0- |
| 01-15 | Cash Withdrawal | 60.00 | -0- | 60.00 |
| 01-20 | Cash Withdrawal | 40.00 | 40.00 | -0- |
| 01-23 | Cash Withdrawal | 20.00 | 20.00 | -0- |
| 01-28 | Cash Withdrawal | 80.00 | -0- | 80.00 |
| | TOTAL | 260.00 | 120.00 | 140.00 |

In addition to the amount threshold parameter, other earlier disclosed parameters can be adapted to cash withdrawals as well, such as remainder threshold (“debit the first $20 of the cash withdrawal from available cash balance #1 and debit any remainder amount above $20 from available cash balance #2”); ratio (“debit 50% of the cash withdrawal from available cash balance #1 and debit the remaining 50% from available cash balance #2”); special identifier information comprising location of transaction origination, etc. (“debit the total amount of the cash withdrawal from available cash balance #1 within 30 miles from my residence, otherwise debit available cash balance #2”); account balance information (“debit cash withdrawals up to $20 from available cash balance #1 and debit cash withdrawals over $20 from available cash balance #2; however, if available cash balance #1 falls below $100, then only debit available account balance #2 for all cash withdrawals”) and, account balance consumption (“if consumption relating to cash withdrawals exceeds $100 for the day, then debit available cash balance #2, otherwise, debit available cash balance #1”, or, “if consumption relating to cash withdrawals exceeds $1000 for the month, then debit available cash balance #2, otherwise, debit available cash balance #1”).

Cash Withdrawals—“Paid In-Turn” Embodiments

This next example shows where cash withdrawals are made, but an initial credit balance is debited by the withdrawal, and within any time interval, such as such as immediately upon or after the debit to the initial available credit balance occurs, or, two minutes, two hours, two days, etc., after the debit to the initial available credit balance occurs, said debit is “paid in-turn” and credited automatically by a debit to the available cash balance, whereby the initial available credit balance is zeroed-out (paid in full).

| | | Amount | Credit Bal | Amt Debited | Net Effect |
|---|---|---|---|---|---|
| Date | Description | Withdrawn | Debit | Frm Cash Bal | Credit Bal |
| 01-02 | Cash Withdrawal | 40.00 | 40.00 | 40.00 | -0- |
| 01-09 | Cash Withdrawal | 20.00 | 20.00 | 20.00 | -0- |
| 01-15 | Cash Withdrawal | 60.00 | 60.00 | 60.00 | -0- |
| 01-20 | Cash Withdrawal | 40.00 | 40.00 | 40.00 | -0- |
| 01-23 | Cash Withdrawal | 20.00 | 20.00 | 20.00 | -0- |
| 01-28 | Cash Withdrawal | 80.00 | 80.00 | 80.00 | -0- |
| | TOTAL | 260.00 | 260.00 | 260.00 | -0- |

Normally when an initial credit balance is debited for a cash withdrawal, it is known as a cash advance, with high interest and fees to go with it. In the above situation, the cash advance is a temporary situation that exists only until it is automatically paid by at least one available cash balance, so it is possible that certain, if not all, fees and interest normally associated with a cash advance would be minimized or waived altogether.

The following example is a “paid in-turn” cash withdrawal embodiment using two available cash balances, although any number of cash balances (or even credit balances) may be used. Here, using an amount threshold parameter, cash withdrawals up to $40 debit cash balance #1, whereby cash withdrawals above $40 debit cash balance #2.

| | | Amount | Credit Bal | Amt Debited | Amt Debited |
|---|---|---|---|---|---|
| Date | Description | Withdrawn | Debit | Cash Bal #1 | Cash Bal #2 |
| 01-02 | Cash Withdrawal | 40.00 | 40.00 | 40.00 | -0- |
| 01-09 | Cash Withdrawal | 20.00 | 20.00 | 20.00 | -0- |
| 01-15 | Cash Withdrawal | 60.00 | 60.00 | -0- | 60.00 |
| 01-20 | Cash Withdrawal | 40.00 | 40.00 | 40.00 | -0- |
| 01-23 | Cash Withdrawal | 20.00 | 20.00 | 20.00 | -0- |
| 01-28 | Cash Withdrawal | 80.00 | 80.00 | -0- | 80.00 |
| | TOTAL | 260.00 | 260.00 | 120.00 | 140.00 |

As disclosed in the earlier cash withdrawal section regarding two or more available cash balance funding sources, in addition to the amount threshold parameter, other parameters adapted to cash withdrawals comprise: remainder threshold (“debit the first $20 of the cash withdrawal amount from available cash balance #1, and debit any remainder amount above $20 from available cash balance #2”); ratio (“debit ⅓ (one third) of the cash withdrawal amount from available cash balance #1, and debit ⅔ (two third) of the cash withdrawal amount from available cash balance #2”); special identifier information comprising location of transaction origination, etc. (“debit the cash withdrawal amount from available cash balance #2 if the cash withdrawal is performed more than 30 miles from my residence”); account balance information (“debit cash withdrawals up to $20 from available cash balance #1 and debit cash withdrawals over $20 from available cash balance #2; however, if available cash balance #1 falls below $100, then only debit available account balance #2 for all cash withdrawals”), and account balance consumption (“if consumption relating to cash withdrawals exceeds $100 for the day, then debit available cash balance #2, otherwise, debit available cash balance #1”, or “(“if consumption relating to cash withdrawals exceeds $1000 for the month, then debit available cash balance #2, otherwise, debit available cash balance #1”).

An important point needs to be made here. As mentioned in the above example, and carrying through to the following examples as well, at least one available credit balance may be used as a funding source, in addition to, or in place of, at least one available cash balance. An available credit balance may comprise any kind of available credit balance, such as a home equity line of credit (heloc). Furthermore, with cash withdrawal parameters that enable a given cash withdrawal to draw from two or more funding sources simultaneously, said funding sources may comprise any combination or permutation of in-house or out-of-house available cash balances and/or in-house or out-of-house available credit balances. Finally, in such embodiments that employ more than one available credit balance, where said more than one available credit balances comprise either at least one initial available credit balance that is debited for the cash withdrawal amount, and/or at least one funding source available credit balance, it is disclosed that any or all available credit balances comprising a given embodiment may comprise identical or different billing cycles.

As with earlier “crebit” methods relating to purchase transactions, two or more payment sources can “back up” each other; so, in the above example if cash balance #1 was depleted, then cash balance #2 can take over using “Best Fit” (debit at least one payment source that can “best fit”, or best accommodate, the cash withdrawal) and/or “Rescue or Reject” (either “rescue” the cash withdrawal by using at least one other non-depleted available balance as a partial/full payment source in place of, or in addition to, the balance(s) depleted before or during the cash withdrawal, or “reject” the cash withdrawal). As that any combination of in-house or out-of-house available cash and/or credit balances may be used as payment sources, the use of any combination of in-house or out-of-house available cash and/or credit balances applies with regards to “Best Fit” and/or “Rescue or Reject” criteria as well.

Cash Withdrawal —“Paid In-Turn”—Depleted Available Cash Balance

In the next example, the cash withdrawals are allowed even when the available cash balance is depleted.

| | | Amount | Credit Bal | Amt Debited | Net Debit |
|---|---|---|---|---|---|
| Date | Description | Withdrawn | Debit | Frm Cash Bal | Credit Bal |
| 01-02 | Cash Withdrawal | 40.00 | 40.00 | 40.00 | -0- |
| 01-09 | Cash Withdrawal | 20.00 | 20.00 | 20.00 | -0- |
| 01-15 | Cash Withdrawal | 60.00 | 60.00 | 60.00 | -0- |
| 01-20 | Cash Withdrawal | 40.00 | 40.00 | 40.00 | -0- |

AVAILABLE CASH BALANCE DEPLETED - SUBSEQUENT CASH
WITHDRAWALS WILL BE TREATED AS “CASH ADVANCES”.

| | | | | | |
|---|---|---|---|---|---|
| 01-23 | Cash Withdrawal | 20.00 | 20.00 | -0- | 20.00 |
| 01-28 | Cash Withdrawal | 80.00 | 80.00 | -0- | 80.00 |
| | TOTAL | 260.00 | 260.00 | 160.00 | 100.00 |

After the 01-20 cash withdrawal, the available cash balance that ordinarily credited the cash withdrawal debits to the initial available credit balance was depleted; however, cash withdrawals were still possible on 01-23 and 01-28 as “cash advances”, which most likely will entail a levy of accrued interest and/or fees, whereby the debits to the initial available credit balance that enabled the cash advances will be paid back by the end user at a future time. It is very important to note that automatically enabling cash withdrawals in excess of any available cash balances (thereby resulting in a “cash advance”) is an optional and additional aspect of the method. It is entirely possible for an account provider to allow or not allow such additional cash advances; furthermore, an end user could have the preset option of allowing cash advances, or to not allow cash advances, in excess of available cash on hand in the end user's account. In such instances where cash advances are not automatically permitted, or are otherwise not desired, any cash withdrawal request that exceeds the available cash balance(s) can be rejected, and/or a query at the point of the cash withdrawal can inform the end user of the deficient cash balances(s) condition, and ask the end user whether a cash advance is desired in place of a cash withdrawal from the end user's available cash balance(s).

Readjustment

Keeping in mind where the debit to the initial credit balance caused by the cash withdrawal is “paid in-turn” by at least one available cash balance, the initial available credit balance that is paid by the at least one available cash balance can be either manually or automatically “unpaid”, or readjusted, where at least one available cash balance is credited for the readjusted amount, and where the readjusted amounts are rendered as open “cash advance” items that are paid back at a future time. As with earlier disclosed purchase transactions, a readjustment is useful for whatever purpose, such as a higher need for the cash, to cover check overdrafts, to pay account related fees, etc.

| | | Amount | Credit Bal | Amt Debited | Net Effect |
|---|---|---|---|---|---|
| Date | Description | Withdrawn | Debit | Frm Cash Bal | Credit Bal |
| 01-02 | Cash Withdrawal | 40.00 | 40.00 | 40.00 | -0- |
| 01-09 | Cash Withdrawal | 20.00 | 20.00 | 20.00 | -0- |
| 01-15 | Cash Withdrawal | 60.00 | 60.00 | 60.00 | -0- |
| 01-20 | Cash Withdrawal | 40.00 | 40.00 | 40.00 | -0- |
| 01-21 | 01-15 Withdrawal Readjusted | | | (60.00) | 60.00 |
| 01-21 | 01-20 Withdrawal Readjusted | | | (40.00) | 40.00 |
| 01-23 | Cash Withdrawal | 20.00 | 20.00 | 20.00 | -0- |
| 01-28 | Cash Withdrawal | 80.00 | 80.00 | 80.00 | -0- |
| | TOTAL | 260.00 | 260.00 | 160.00 | 100.00 |

On 01-21, the end user performed a readjustment on the 01-15 and 01-20 cash withdrawals, thereby unpaying (debiting) the initial available credit balance for $100, and crediting the available cash balance for $100. The end user will repay the “unpaid” debit to the initial available credit balance at a future time. In embodiments comprising more than one available cash balance source, it is herein disclosed, as per earlier purchase transactions, that a credit to at least one available cash balance as a result of a readjustment can be either to the cash balance originally used to pay the initial credit balance, and/or to at least one additional available cash balance. Such readjustments may occur manually, whereby an end user “manually” unpays a particular cash withdrawal with an online account entry, assistance from a customer service representative, etc. (resulting in an open item “cash advance”), or automatically, whereby a paid cash withdrawal is automatically readjusted, for any reason, such as where the resultant cash is used to prevent a draft from bouncing. Any “unpayment” is reasonably expected to be repaid; furthermore, an “unpayment” that is repaid may in fact be unpaid again being that this disclosure places no theoretical limits on the number of times a given cash withdrawal that has been paid can be subsequently unpaid (readjusted) and then repaid, unpaid again, etc. While the number of times a cash withdrawal can be paid/unpaid/repaid is theoretically unlimited, the account provider could decide whether or not to place limitations.

Cash Withdrawals—“Paid Together” Embodiments

In the following example, cash withdrawals debit the initial available credit balance; however, instead of paying the individual debits to the initial available credit balance “in-turn” with at least one available cash balance, the at least one available cash balance is cumulatively frozen, suspended, earmarked, or otherwise allocated for the amounts of the cash withdrawals, and the cash withdrawals are “paid together” at a given time, such as on a specific date, after a given time interval, such as every two weeks or after the close of a billing cycle, using the cumulatively frozen cash balance.

| | | Amount | Credit Bal | Cash Bal | Net Effect |
|---|---|---|---|---|---|
| Date | Description | Withdrawn | Debit | Frozen | Credit Bal |
| 01-02 | Cash Withdrawal | 40.00 | 40.00 | 40.00 | 40.00 |
| 01-09 | Cash Withdrawal | 20.00 | 20.00 | 60.00 | 60.00 |
| 01-15 | Cash Withdrawal | 60.00 | 60.00 | 120.00 | 120.00 |
| 01-20 | Cash Withdrawal | 40.00 | 40.00 | 160.00 | 160.00 |
| 01-23 | Cash Withdrawal | 20.00 | 20.00 | 180.00 | 180.00 |
| 01-28 | Cash Withdrawal | 80.00 | 80.00 | 260.00 | 260.00 |

FROZEN CASH BALANCE IS DEBITED TO CREDIT
CASH WITHDRAWAL DEBIT AMOUNTS

| | | | | |
|---|---|---|---|---|
| TOTAL | 260.00 | -0- | -0- | -0- |

On 01-31, the cumulatively frozen cash amount of $260 was transferred (debited) to credit the debits to the initial credit balance caused by the cash withdrawals. While either the end user and/or the account provider can perform such transfers manually, it is reasonable that automated transfers would be preferable in most instances.

As disclosed earlier regarding “paid in-turn” cash withdrawal embodiments, any “paid together” cash withdrawal embodiments can comprise at least one available cash balance funding source and/or at least one available credit balance funding source. As with the “paid in-turn” cash withdrawal embodiments, any “paid together” cash withdrawal embodiments can comprise any cash withdrawal parameters to determine which one or more than one of the at least one funding source will be used, such parameters comprising: amount threshold; remainder threshold; ratio; special identifier information comprising location of transaction origination, etc.; and, account balance information. Prepayment is also a possibility, where at least one cash withdrawal is manually or automatically paid prior to the time when the cash withdrawals are paid together (where, per the above example, prepayment would occur prior to the 01-31 crediting of the cash withdrawal debit amounts). Such prepayments can occur using an online entry, customer service representative, etc. Furthermore, such prepayment can be subsequently readjusted (unpaid), and repaid again. In fact, this disclosure places no theoretical limits on the amount of times a given cash withdrawal can be prepaid, unpaid, then repaid prior to the transactions being “paid together”. Even after the transactions are paid together, it is within the scope of this disclosure to enable at least one subsequent readjustment or “unpayment” of the “paid together” transactions.

Cash Withdrawals—“Paid Together”—Depleted Available Cash Balance

This example shows a “paid together” embodiment whereby the available cash balance available for freezing becomes depleted. As a result of the depletion condition, no additional cash balance funds can be allocated to pay for the debits to the initial credit balance that result due to the cash withdrawals.

| | | Amount | Credit Bal | Cash Bal | Net Effect |
|---|---|---|---|---|---|
| Date | Description | Withdrawn | Debit | Frozen | Credit Bal |
| 01-02 | Cash Withdrawal | 40.00 | 40.00 | 40.00 | 40.00 |
| 01-09 | Cash Withdrawal | 20.00 | 20.00 | 60.00 | 60.00 |
| 01-15 | Cash Withdrawal | 60.00 | 60.00 | 120.00 | 120.00 |
| 01-20 | Cash Withdrawal | 40.00 | 40.00 | 160.00 | 160.00 |

ZERO CASH RESERVES REMAIN FOR FREEZING - SUBSEQUENT CASH
WITHDRAWALS WILL BE TREATED AS “CASH ADVANCES”.

| | | | | | |
|---|---|---|---|---|---|
| 01-23 | Cash Withdrawal | 20.00 | 20.00 | 160.00 | 180.00 |
| 01-28 | Cash Withdrawal | 80.00 | 80.00 | 160.00 | 260.00 |

FROZEN CASH BALANCE IS DEBITED TO PARTIALLY CREDIT CASH
WITHDRAWAL DEBIT AMOUNTS

| | | | | |
|---|---|---|---|---|
| TOTAL | 260.00 | -0- | -0- | 100.00 |

After the 01-20 cash withdrawal, the available cash balance that sourced the frozen cash balance was depleted; however, cash withdrawals were still possible on 01-23 and 01-28 as “cash advances. As analogous with the earlier “paid in-turn” embodiment, kindly note that automatically enabling cash withdrawals in excess of the capability to allocate frozen cash balance amounts (thereby resulting in a “cash advance”) is an optional aspect of the method. It is entirely possible for an offering entity to allow or not allow such additional cash advances; furthermore, an end user could have the preset option of allowing cash advances, or to not allow cash advances, in excess of the capability to allocate frozen cash balance amounts in the end users account. In such instances where cash advances are not automatically permitted, or are otherwise not desired, any cash withdrawal request that exceeds the capability to allocate frozen cash balance amounts can be rejected, and/or a query at the point of the cash withdrawal can inform the end user of the deficiency regarding the cash balance(s) condition, and ask the end user whether a cash advance is desired.

Withdrawing Funds from the Frozen Cash Balance

In the next example, funds are withdrawn from the frozen cash balance for any number of reasons, such as the end user “manually” withdraws the frozen funds, or frozen funds are “automatically” withdrawn to cover a check overdraft, a fee, etc.

| | | Amount | Credit Bal | Cash Bal | Net Effect |
|---|---|---|---|---|---|
| Date | Description | Withdrawn | Debit | Frozen | Credit Bal |
| 01-02 | Cash Withdrawal | 40.00 | 40.00 | 40.00 | 40.00 |
| 01-09 | Cash Withdrawal | 20.00 | 20.00 | 60.00 | 60.00 |
| 01-15 | Cash Withdrawal | 60.00 | 60.00 | 120.00 | 120.00 |
| 01-20 | Cash Withdrawal | 40.00 | 40.00 | 160.00 | 160.00 |
| 01-21 | FROZEN CASH BALANCE WITHDRAWN | | | (60.00) | 160.00 |
| 01-23 | Cash Withdrawal | 20.00 | 20.00 | 120.00 | 180.00 |
| 01-28 | Cash Withdrawal | 80.00 | 80.00 | 200.00 | 260.00 |

01-31 FROZEN CASH BALANCE IS DEBITED TO PARTIALLY
CREDIT CASH WITHDRAWAL DEBIT AMOUNTS

| | | | | |
|---|---|---|---|---|
| TOTAL | 260.00 | 60.00 | -0- | 60.00 |

On 01-21, $60 is withdrawn from the frozen cash balance, resulting in a $60 shortfall in the 01-31 frozen cash balance debiting/initial credit balance crediting, whereby the $60 remains open as a “cash advance” to be repaid later by the end user. Conventional wisdom dictates that a “frozen” balance remains frozen until the intended “unfreezing” and/or transfer debiting occurs; however, it is disclosed herein that, in given embodiments, account providers can optionally allow where frozen balances can be “tampered” with, either manually or automatically, for whatever purpose, and by whatever implementation (a manual unfreezing/withdrawal by the end user who has a higher need for the cash, an automatic unfreezing/withdrawal by the account provider to cover check overdrafts, an automatic unfreezing/withdrawal by the account provider to pay account related fees, etc.), which basically totally destroys the traditional intended purpose of a frozen balance. A frozen cash balance can be part of at least one unfrozen available cash balance, and/or the frozen cash balance can comprise at least one available balance entirely separate from the at least one unfrozen available cash balance. Also, whether or not frozen cash balances, or frozen portions of available cash balances, are interest bearing, is an option to be determined, such as by those implementing the disclosed methods such as the account provider.

Cash Withdrawals—Transactions Automatically and Individually Paid In-Turn, then Automatically and Individually Readjusted In-Turn with Plural Transactions Automatically Paid Together at a Given Time Interval

This unique hybrid for cash withdrawals comprises where individual cash withdrawals on the initial credit balance are automatically paid, then automatically unpaid (readjusted), then the plurality of cash withdrawals are cumulatively and automatically paid together at a given later time interval. The readjusted credit balance can be the initial credit balance, and/or at least one different balance entirely, just as the readjusted frozen cash balance amounts can comprise the initial cash balance, and/or at least one different balance entirely. This hybrid embodiment has an unpaid readjustment function as a core aspect of its operation.

| | | | | | Readjusted |
|---|---|---|---|---|---|
| | | Amount | Credit Bal | Cash Bal Amt | Frozen Cash |
| Date | Description | Withdrawn | Debit | Paid/Unpaid | Balance |
| 01-02 | Cash Withdrawal | 40.00 | 40.00 | 40.00 | 40.00 |
| 01-09 | Cash Withdrawal | 20.00 | 20.00 | 20.00 | 60.00 |
| 01-15 | Cash Withdrawal | 60.00 | 60.00 | 60.00 | 120.00 |
| 01-20 | Cash Withdrawal | 40.00 | 40.00 | 40.00 | 160.00 |
| 01-23 | Cash Withdrawal | 20.00 | 20.00 | 20.00 | 180.00 |
| 01-28 | Cash Withdrawal | 80.00 | 80.00 | 80.00 | 260.00 |

FROZEN CASH BALANCE IS DEBITED TO CREDIT CASH
WITHDRAWAL DEBIT AMOUNTS

| | | | | |
|---|---|---|---|---|
| TOTAL | 260.00 | -0- | -0- | -0- |

Per the above, the readjusted frozen cash balance that is debited to credit the cash withdrawal credit balance debit amounts can, depending on the embodiment, be fully or partially “unfrozen” and withdrawn by either the account issuer or the end user for whatever reasons; or, a given embodiment could prohibit such unfreezing. Unfrozen funds that are withdrawn and not somehow restored will result in open cash advance items that the end user will be expected to repay later.

Cash Withdrawals—Combination “Paid in Turn” and “Paid Together” Embodiments

This cash withdrawal example is a combines “paid in-turn” and “paid together” aspects using two available cash balances. Using an amount threshold parameter, cash withdrawals up to $40 debit cash balance #1, where the cash withdrawals are “paid in-turn”, whereby cash withdrawals above $40 debit cash balance #2, where the amounts are frozen, and “paid together” at the end of the month.

| | | Amount | Credit Bal | Amt Debited | Amt Frozen |
|---|---|---|---|---|---|
| Date | Description | Withdrawn | Debit | Cash Bal #1 | Cash Bal #2 |
| 01-02 | Cash Withdrawal | 40.00 | 40.00 | 40.00 | -0- |
| 01-09 | Cash Withdrawal | 20.00 | 20.00 | 20.00 | -0- |
| 01-15 | Cash Withdrawal | 60.00 | 60.00 | -0- | 60.00 |
| 01-20 | Cash Withdrawal | 40.00 | 40.00 | 40.00 | -0- |
| 01-23 | Cash Withdrawal | 20.00 | 20.00 | 20.00 | -0- |
| 01-28 | Cash Withdrawal | 80.00 | 80.00 | -0- | 140.00 |

FROZEN FUNDS FROM CASH BALANCE #2 ARE DEBITED TO
CREDIT ALL CASH WITHDRAWAL DEBIT AMOUNTS ABOVE $40

| | | | | |
|---|---|---|---|---|
| TOTAL | 260.00 | 260.00 | 120.00 | PAID |

Cash Withdrawals Using Two or More Initial Credit Balances

The following “paid in-turn” example shows where cash withdrawals can debit at least two initial credit balances. Using an amount threshold parameter, cash withdrawal up to $40 debit initial available credit balance #1, where cash withdrawal amounts above $40 debit initial credit balance #2. There could be any reason for using at least two initial credit balances, such as where one balance is in-house where the other is out-of-house, different billing cycles, withdrawal minimum or maximums for a given available credit balance, (such as a daily maximum), etc.

| | | Amount | Ini Credit | Ini Credit | Amt Debited |
|---|---|---|---|---|---|
| Date | Description | Withdrawn | #1 Debit | #2 Debit | Cash Bal |
| 01-02 | Cash Withdrawal | 40.00 | 40.00 | -0- | 40.00 |
| 01-09 | Cash Withdrawal | 20.00 | 20.00 | -0- | 20.00 |
| 01-15 | Cash Withdrawal | 60.00 | -0- | 60.00 | 60.00 |
| 01-20 | Cash Withdrawal | 40.00 | 40.00 | -0- | 40.00 |
| 01-23 | Cash Withdrawal | 20.00 | 20.00 | -0- | 20.00 |
| 01-28 | Cash Withdrawal | 80.00 | -0- | 80.00 | 80.00 |
| | TOTAL | 260.00 | 120.00 | 140.00 | 260.00 |

In addition to the amount threshold parameter, other earlier disclosed parameters can be adapted to initial credit balance debiting as well, such as remainder threshold (“debit the first $20 of the cash withdrawal from initial credit balance #1 and debit any remainder amount above $20 from initial credit balance #2”); ratio (“debit 50% of the cash withdrawal from initial credit balance #1 and debit the remaining 50% from initial credit balance #2”); special identifier information comprising location of transaction origination, etc. (“debit the total amount of the cash withdrawal from initial credit balance #1 within 30 miles from my residence, otherwise debit initial credit balance #2”); account balance information (“debit cash withdrawals up to $20 from initial credit balance #1 and debit cash withdrawals over $20 from initial credit balance #2; however, if initial credit balance #1 falls below $1000, then only debit available account balance #2 for all cash withdrawals”) and, account balance consumption (“if consumption of initial credit balance #1 exceeds $100 for the day, then debit initial credit balance #2, otherwise, debit initial credit balance #1”, or, “if consumption initial credit balance #1 exceeds $1000 for the month, then debit initial credit balance #2, otherwise, debit initial credit balance #1”). Consumption is an important aspect to consider, as account providers tend to have daily limits regarding how much can be withdrawn from an ATM against a given credit or cash balance, so being able to employ more than one initial credit balance could be useful.

Cash Withdrawals—Determining Whether to Pay or Leave Unpaid as and Open Cash Advance

Cash withdrawal parameters can also enable which cash withdrawals are to be left unpaid as an open “cash advance” item that is to be repaid at a future time. In this “paid in-turn” example using amount threshold parameters, cash withdrawal amounts up to $20 are paid using available balance #1 (Bal #1), which is an available cash balance; cash withdrawal amounts above $20 up to $40 are paid using available balance #2 (Bal #2), which is an available credit balance, such as a home equity line of credit (heloc), and cash withdrawal amounts above $40 are left unpaid as an open “cash advance” which the end user will repay at a future date.

| | | Amount | Ini Credit | Amt Debited | Amt Debited | Cash |
|---|---|---|---|---|---|---|
| Date | Description | Withdrawn | Bal Debit | Bal #1 | Bal #2 | Advance |
| 01-02 | Cash Withdrawal | 40.00 | 40.00 | -0- | 40.00 | -0- |
| 01-09 | Cash Withdrawal | 20.00 | 20.00 | 20.00 | -0- | -0- |
| 01-15 | Cash Withdrawal | 60.00 | 60.00 | -0- | -0- | 60.00 |
| 01-20 | Cash Withdrawal | 40.00 | 40.00 | -0- | 40.00 | -0- |
| 01-23 | Cash Withdrawal | 20.00 | 20.00 | 20.00 | -0- | -0- |
| 01-28 | Cash Withdrawal | 80.00 | 80.00 | -0- | -0- | 80.00 |
| | TOTAL | 260.00 | 260.00 | 40.00 | 120.00 | 140.00 |

While the amount threshold parameter enables higher value cash withdrawals to remain as cash advances, the opposite (enabling lower value cash withdrawals to remain as cash advances) are also possible. While the practicality of the above can possibly be called into question in terms of fees and interest, the above example basically illustrates the possibilities. In addition to the amount threshold parameter illustrated, any cash withdrawal parameters, such as: remainder threshold (“for cash withdrawal amounts up to $20, debit the available cash balance to credit the debit to the available credit balance created by the cash withdrawal, and leave any remainder amount above $20 as an open cash advance”); ratio (debit the available cash balance to credit the debit to the available credit balance for ¾ (three quarters) of the cash withdrawal amount, and leave the remaining ¼ (one quarter) of the cash withdrawal amount as an open cash advance“; special identifier information comprising location of cash withdrawal, etc. (”if cash withdrawal occurs more than 100 miles from my primary residence, treat as a cash advance“); and, account balance information (”if the available cash balance falls below $100, allow the cash withdrawal to remain as an open debit cash advance to the available credit balance”) may be used. Furthermore, and very importantly, the above example demonstrates where available cash balances (Bal #1) and available credit balances (Bal #2) are used as payment sources for cash withdrawals.

Parameters

The logic of the presented parameter can be reduced basically down to “if/then” statements, such as “if the cash withdrawal is more than $40, then debit available balance #2”. Such parameters can involve simple “if/then” instructions, simple “if” instructions with complex “then” instructions, complex multi-conditional “if” instructions with simple “then” instructions, or complex multi-conditional “if” instructions with complex “then” instructions. An example of the later is: “if the cash withdrawal exceeds $40, and is within 30 miles of my residence, and results in consumption of available balance number remaining under $1000, then debit 50% of the cash withdrawal from available balance #1, 25% of the cash withdrawal amount from available balance #2, and 25% of the cash withdrawal amount from available balance #3; however, if the cash withdrawal is $40 or less, and is within 100 miles of my residence, and results in consumption of available balance #1 under $500, then debit 100% of the cash withdrawal from available balance #1—if neither of these condition sets apply, then debit available balance #4 instead”.

Credit Limit

With regards to cash withdrawals/cash advances, an important matter concerns the credit limit comprising one or more credit balances that enable cash withdrawals/cash advances. Being that myriad possibilities exist with regards to establishing, setting, or revising credit limit(s) on one or more credit balances, this disclosure places no specific guidance or limitations, whereby the issuer is wide open to use any metric(s) for establishing, setting, or revising credit limit(s) that the issuer pleases, regardless of whether the credit limit(s) mirror or otherwise resemble the amount of the available unfrozen and/or frozen cash balance(s); whether credit limit(s) track, somewhat exceed, greatly exceed, etc. any available cash balance amounts; or, where credit limit(s) are totally or somewhat related, or totally or somewhat unrelated, to any available cash balance amounts or available cash balance parameters.

Series and/or Parallel Transaction Movement

Per the embodiments presented above, transaction movement relating to cash withdrawals may comprise two distinct methods:

Where the transaction movement comprises the simple movement or shifting of a given transaction/transaction amount between two like-kind balances (from a credit balance to another credit balance, or from a cash balance to another cash balance); or,

Where the transaction movement comprises the actual crediting and/or debiting of a given transaction/transaction amount, which facilitates the movement of the transaction/transaction amount between either like-kind balances (from a credit balance to another credit balance), or non like-kind balances (from a credit balance to a cash balance, or vice versa).

A given embodiment may comprise either or both methods. Keeping this in mind, any of the disclosed embodiments, from the simple to the complex, may additionally comprise complex transaction movement routines that employ any number, or kind of extra balances (regardless of whether the balances are cash balances or credit balances, or in-house or out-of-house balances), in any order, whereby nearly infinite variations are possible. Furthermore, a given transaction/transaction amount can be moved in series from one balance to another, and/or parallel through more than one balance simultaneously. These complex routines can easily take place without the end-user ever knowing or suspecting. For example, in a “crebit” cash withdrawal embodiment, a given incoming transaction/transaction amount can be moved in series and/or parallel through any number, kind and order of balances before residing on the disclosed “initial available credit balance” comprising the “crebit” embodiment. Also, in a given embodiment, a debit of any cash balances, regardless of whether they are frozen or not, can be moved in series and/or parallel through any number, type and order of balances, regardless of whether any of the balances are deemed “frozen” or not, before the debit ultimately credits another balance, such as an initial available credit balance. The same applies to out-of-house credit or cash balances comprising a given embodiment, where a given transaction/transaction amount moves through a complex routine of balances.

As an overview for a given embodiment, a given incoming transaction/transaction amount debit or credit can move in series and/or parallel through any number, kind and order of balances before ultimately residing on the desired balance, as can an offsetting credit or debit. Readjustments can work the same way, whereby a given readjustment can have its crediting and debiting functions move in series and/or parallel through any number, kind and order of balances prior to consummation, as can any repayment pertinent to a given readjustment. As a result, a complex transaction movement routine can comprise a few, a dozen, a hundred, etc., cash and/or credit balances, in any order, before a transaction/transaction amount debit or credit ultimately resides on the desired initial or ultimate balance. Similarly, a complex transaction movement routine can comprise a few, a dozen, a hundred, etc., cash and/or credit balances, in any order, in order to perform an offsetting balance credit or debit, readjustment, repayment, etc.

End-User Security

An especially salient advantage to the “crebit” methods of cash withdrawals pertains to end-user security. Normally, when a standard debit card is stolen, fraudulent cash withdrawals generally presents difficulties to the rightful account owner, especially with regard to bounced checks, and related issues comprising late fees levied by payees, possible credit rating issues, embarrassment, etc. due to inadequate cash balances. Also, once the fraudulent cash withdrawals are reported, it often takes weeks for the cash to be restored to the account owner. With the “crebit” methods, problems regarding stolen cards that result in fraudulent cash withdrawals can be somewhat minimized, in that any fraudulent “paid in-turn” cash withdrawals can be automatically readjusted to help prevent bounced checks, and any fraudulent “paid together” cash withdrawals can have funds automatically unfrozen or unallocated to help prevent bounced checks. Also, after such fraudulent withdrawals, the end user can “manually” readjust/unfreeze the amounts, either by himself online, and/or by having the account issuer perform the operation (depending on the capabilities that the account issuer provides or allows). In either embodiment, the end result of the readjustments/unfreezing are fraudulent open “cash advance” entries that the account issuer can easily remove, ultimately resulting where the methods spare the end user a multitude of difficulties. In this way, the “crebit” cash withdrawal methods provide the end user with an extra layer of defense against unlawful perpetrators when compared to standard cash withdrawal methods.

1. A method for making at least one flexible or pre-assigned cash withdrawal from two or more associated accounts comprising at least one credit account and at least one cash account, comprising
a. providing said at least one credit account associated with at least one cash account with user access for at least one cash withdrawal;
b. making said at least one cash withdrawal from at least one initial available credit balance or combination thereof, and within at least one time interval after said cash withdrawal, at least one debit corresponding to at least a portion of said cash withdrawal is credited to or by at least a part of said at least one cash account or said at least one credit account.

2. A method according to claim 1, wherein said portion of said cash withdrawal can be any percentage or portion of said at least one cash withdrawal amount.

3. A method according to claim 2, wherein said percentage is 0.001 to 100 percent or any portion thereof.

4. A method according to claim 2, wherein said portion is 0.001 to at least 100,000 US dollars or any foreign equivalent thereof.

5. A method according to claim 1, wherein said at least one debit is paid off by at least one cash balance of said at least one cash account.

6. A method according to claim 5, the timing of at least one debit pay off is at any given time interval after said cash withdrawal or at the end of at least one billing cycle of said at least one credit or cash account, wherein said time interval or billing cycle from said at least one credit or cash account can be modified, extended, or transferred to a different credit or cash account.

7. A method according to claim 6, wherein said time interval is selected from immediately, <1-60 seconds, 1-60 minutes, 1-24 hours, 1-52 weeks, 1-50 years, or any portion thereof.

8. A method according to claim 1, wherein said at least one debit can be transferred to another credit or cash account.

9. A method according to claim 5, wherein said pay off is done automatically based on any parameter set by the end user or any default parameter set by the account provider of said at least one cash account and said at least one credit account.

10. A method according to claim 1, wherein said at least one cash withdrawal includes multiple cash withdrawals.

11. A method according to claim 10, wherein said debits relating to said multiple cash withdrawals are paid in any specific order or combination selected by default settings, the end user or the account provider.

12. A method according to claim 11, wherein said order or combination is selected from chronological, withdrawal amount, debit amount, a threshold amount, a maximum amount or a minimum amount, or any combination thereof.

13. A method according to claim 1, further comprising wherein said at least one debit is moved from at least one credit account or at least one cash account to at least one other credit account or at least one other cash account.

14. A method according to claim 13, wherein said other credit account has a different billing cycle.

15. A method according to claim 1, wherein prior to or at the time of said cash withdrawal, an available cash balance is increased by transferring at least one cash balance in at least one of said cash accounts to at least one credit balance in at least one credit accounts, such that said available cash balance is increased by an automatic or predetermined amount.

16. A method according to claim 15, wherein said transferred cash balance is paid back at a later time.

17. A system for making at least one flexible or pre-assigned cash withdrawal from two or more associated accounts comprising at least one credit account and at least one cash account, comprising
a. a system component for providing said at least one credit account associated with at least one cash account with user access for at least one cash withdrawal;
b. a system component for making said at least one cash withdrawal from at least one initial available credit balance or combination thereof, and within at least one time interval after said cash withdrawal, at least one debit corresponding to at least a portion of said cash withdrawal is credited to or by at least a part of said at least one cash account or said at least one credit account.

18. A system according to claim 17, wherein said portion of said cash withdrawal can be any percentage or portion of said at least one cash withdrawal amount.

19. A system according to claim 18, wherein said percentage is 0.001 to 100 percent or any portion thereof.

20. A system according to claim 18, wherein said portion is 0.001 to at least 100,000 US dollars or any foreign equivalent thereof.

21-32. (canceled)
